(19) United States
(12) Patent Application Publication
(10) Pub. No.: US 2016/0074917 A1
(43) Pub. Date: Mar. 17, 2016

(54) HOLLOW THREADED EXTRUSION SEGMENTS

(71) Applicant: Schaeffler Technologies AG & Co. KG, Herzogenaurach (DE)

(72) Inventor: Timothy SIMON, Wooster, OH (US)

(21) Appl. No.: 14/854,980

(22) Filed: Sep. 15, 2015

Related U.S. Application Data
(60) Provisional application No. 62/051,564, filed on Sep. 17, 2014.

(51) Int. Cl. B21C 37/15; F16B 37/00

(52) U.S. Cl. CPC B21C 37/15; F16B 37/00

(57) ABSTRACT

A method of forming a hollow threaded part is provided. The method includes extruding a blank to form an annular protrusion and forming threads along an inner circumferential surface of the annular protrusion. A hollow threaded part is also provided. The hollow threaded art includes a base and a hollow threaded protrusion segment formed integrally within the base. The hollow threaded protrusion segment includes an annular protrusion extruded from the base.

This claims the benefit to U.S. Provisional Patent Application No. 62/051,564 filed on Sep. 17, 2014, which is hereby incorporated by reference herein.

The present disclosure relates generally to threaded plates and more particularly to hollow threaded protrusion segments in plates.

### BACKGROUND

Conventionally, hollow threaded protrusion segments in plates are formed by punching a clinch nut into a hole preformed in the plate. Clinch nuts may have a high variation after they are fixed in their plates and require specialized tooling.

Additionally, hollow threaded protrusion segments in plates are formed by flow drilling, which involves expanding a pierced hole by a spinning tool. A disadvantage of flow drilling is a decreasing wall thickness of the protrusion.

### SUMMARY OF THE INVENTION

A method of forming a hollow threaded part is provided. The method includes extruding a blank to form an annular protrusion and forming threads along an inner circumferential surface of the annular protrusion.

A hollow threaded part is also provided. The hollow threaded art includes a base and a hollow threaded protrusion segment formed integrally within the base. The hollow threaded protrusion segment includes an annular protrusion extruded from the base.

### BRIEF DESCRIPTION OF THE DRAWINGS

The present invention is described below by reference to the following drawings, in which:

FIG. 1 shows a perspective cross-sectional view of a hollow threaded part in accordance with an embodiment of the present invention; and

FIGS. 2a to 2e schematically illustrate sequential increments of an extrusion of a blank in a method of forming hollow threaded part in accordance with an embodiment of the present invention.

### DETAILED DESCRIPTION

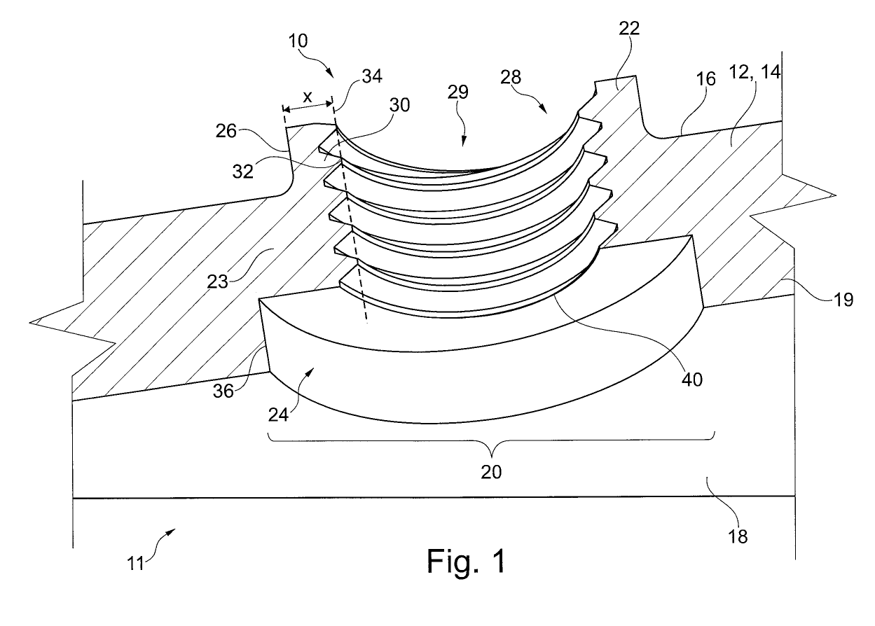

FIG. 1 shows a perspective cross-sectional view of a hollow threaded part 11 including a hollow threaded protrusion segment 10 formed integrally within a base 12 of hollow threaded part 11, which is formed by a flat plate 14, in accordance with an embodiment of the present invention. Prior to the formation of hollow threaded protrusion segment 10, a first planar surface 16 (top surface as shown in FIG. 1) of plate 14 and a second planar surface 18 (bottom surface as shown in FIG. 1) of plate 14 extended as flat continuous surfaces connected by a continuous interior 19 extending contiguously between surfaces 16, 18 in an area 20 where hollowed threaded protrusion segment 10 is positioned in FIG. 1.

As shown in FIG. 1, hollow threaded protrusion segment 10 includes an annular protrusion 22 projecting radially away from both first surface 16 and interior 19, an annular depression 24 extending radially into both second surface 18 and interior 19, and a base section 23 axially between protrusion 22 and depression 24. Base section 23 is contiguous with interior 19. Protrusion 22 includes a cylindrical outer circumferential surface 26 that is substantially smooth. Protrusion 22 and base section 23 include a threaded inner circumferential surface 28 formed by a projecting helical rib 30 winding around inner circumferential surface 28. Threaded inner circumferential surface 28 delimits a threaded hole 29 passing completely through hollow threaded protrusion segment 10 that is configured for receiving a threaded fastener, such as a screw or bolt. An innermost tip 32 of rib 30, i.e., innermost with respect to the center of hollow threaded protrusion segment 10, defines a cylindrically aligned innermost surface 34 of hollow threaded protrusion segment 10. In a preferred embodiment, protrusion 22 has a consistent thickness X between innermost surface 34 and outer circumferential surface 26 Annular depression 24 is delimited by a cylindrical outer circumferential surface 36 that is substantially smooth and a flat annular surface 38 that is substantially smooth and is aligned parallel to first and second surfaces 16, 18. Inner circumference 40 of annular surface 38 is contiguous with threaded inner circumferential surface 28.

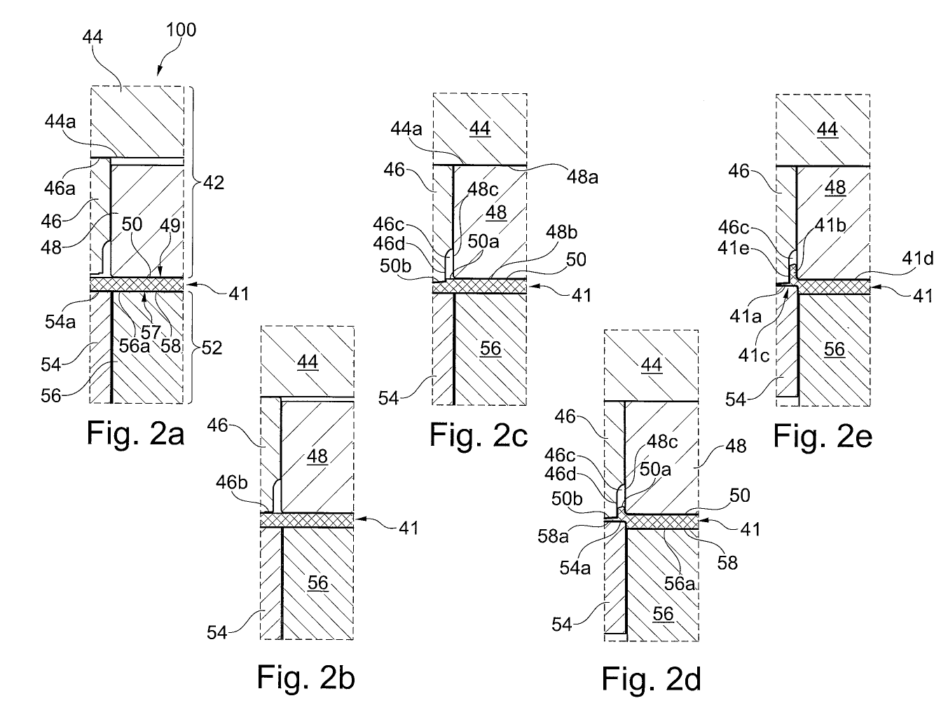

FIGS. 2a to 2e schematically illustrate sequential increments of an extrusion of a blank 41 in a method of forming hollow threaded part 11 in accordance with an embodiment of the present invention. FIGS. 2a to 2e each schematically show a right half, as viewed in FIGS. 2a to 2e, of a die 100 for extruding blank 41. Die 100 includes a first section 42, or stamp section, formed by an external die subsection 44, i.e., an external stamp subsection, contacting and forcing two independently movable internal die subsections 46, 48, i.e., internal stamp subsections, into a first surface 50 of blank 41, which forms first surface 16 of plate 14, on a first side 49 of blank 41. Die 100 also includes a second section 52, or block section, formed by two subsections 54, 56, i.e., block subsections, for contacting a second surface 58 of blank 41, which is on a second side 57 of blank 41 opposite first side 49 and forms second surface 18 of plate 14. Block subsection 56 is movable independent of block section 54, which is axially fixed during the extrusion of blank 41.

FIG. 2a shows die 100 at the beginning of operation before the extrusion of blank 41. Blank 41 is a flat plate in this embodiment. Second surface 58 of blank 41 rests on support surfaces 54a, 56a of subsections 54, 56, respectively. Surfaces 54a, 56a are aligned in the same plane. Subsection 44 is moved toward surface 50 of blank 41 such that a contact surface 44a of subsection 44 contacts an outer surface 46a of subsection 46. Neither of subsections 46, 48 is being pressed into side 49 of blank 41 by subsection 44 in FIG. 2a.

FIG. 2b shows the beginning of the extrusion of blank 41. Subsection 44 is moved further toward side 49 of blank 41 such that surface 44a of subsection 44 forces subsection 46 into blank 41, causing a stamping surface 46b of subsection 46 to contact surface 50 of blank 41. In this embodiment, stamping surface 46b is formed by a conical tip. Subsection 54 remains in place and provides an axially fixed backstop for subsection 46. Subsection 44 is not yet forcing subsection 48 into surface 50 of blank 41.

FIG. 2c shows die 100 continuing to extrude blank 41. Subsection 44 continues to force subsection 46 into side 49 of blank 41 and subsection 54 remains in an axially fixed position as a backstop for subsection 46. Surface 44a of subsection 44 is also in contact with an outer surface 48a of subsection 48 such that surface 44a of subsection 44 forces subsection 48 into blank 41, causing a flat stamping surface 48b of subsection 48 to contact surface 50 of blank 41. A portion 50a of blank 41 is beginning to displace away from surface 50 outwardly into a gap 46c provided between a cylindrical outer circumferential surface 46d of subsection 46 and a cylindrical inner circumferential surface 48c of subsection 48. In this embodiment, gap 46c is formed by an annular groove formed in cylindrical outer circumferential surface 46d of subsection 46. The displacement of portion 50a is caused by stamp surface 46b forming a depression 50b into blank 41.

FIG. 2d shows subsection 44 continuing to force subsections 46, 48 into blank 41 via contact between surface 44a and surfaces 46a, 48a. Stamping surfaces 46b, 48b continue the extrusion of blank 41, further displacing portion 50a at side 49 of blank 41 to protrude outward and further extending depression 50b inward into blank 41. Displaced portion 50a extends further into gap 46c and is shaped by cylindrical outer circumferential surface 46d and cylindrical inner circumferential surface 48c. Meanwhile, subsection 44 continues to force subsection 48 against blank 41, while subsection 54 remains in an axially fixed position as a backstop for subsection 46 and subsection 56 acts as an axially movable backstop for subsection 48. This causes surface 56a of subsection 56 to move axially away from surface 54a, i.e., downward, such that the plane of surface 56a is offset from the plane of surface 54a, which results in a cylindrical depression 58a being formed into blank 41 offset from surface 58. An outer circumferential surface of cylindrical depression 58a is slightly radially outside of an outer circumferential surface of displaced portion 50a.

FIG. 2e shows blank 41 and die 100 at the end of the extrusion of blank 41 by die 100. In comparison to FIG. 2d, subsection 44 has further forced subsections 46, 48 into blank 41, further displacing portion 50a to protrude outward into gap 46c and further extending depression 50b inward into blank 41. Additionally, the axial immobility of subsection 54 and the axial mobility of subsection 56 has caused surface 56a of subsection 56 to move axially further away from surface 54a, which results in depression 58a further extending depression 50b inward into blank 41. As a result of depressions 50b, 58a, blank 41 includes a thinned section 41a at the center thereof aligned with surfaces 46b, 54a. Radially outside of thinned section 41a on side 49, blank 41 includes an annular protrusion 41b formed by displaced portion 50a. Aligned with thinned section 41a and protrusion 41b, on side 57 blank 41 includes a cylindrical depression 41c formed by depression 58a. Radially outside of depression 41c and protrusion 41b, blank 41 includes a base portion 41d that remains plate shaped.

After the extrusion of blank 41 is complete, in a press of die 100, blank 41 is pierced at thinned section 41a to form a hole, and an inner circumferential surface 41e of protrusion 41b is machined to form threaded inner circumferential surface 28. Threads of threaded inner circumferential surface 28 may be added by cutting or rolling, which may be performed directly in die 100. After the piercing and machining, protrusion 41b forms annular protrusion 22, the hole pierced into thinned section 41a forms threaded hole 29 at base section 23, depression 41c forms annular depression 24 and base portion 41d forms plate 14, thus forming hollow threaded part 11 shown in FIG. 1. As noted above, hollow threaded part 11 is advantageously formed as a single piece of the same material, i.e., metal, including hollow threaded protrusion segment 10 formed integrally within base 12, which is formed by a plate 14.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A method of forming a hollow threaded part comprising:
extruding a blank to form an annular protrusion; and
forming threads along an inner circumferential surface of the annular protrusion.

2. The method of claim 1 wherein the extruding includes stamping a thinned section into the blank radially inside of the annular protrusion.

3. The method of claim 2 further comprising piercing the thinned section to form a hole before forming the threads.

4. The method of claim 1 wherein the extruding includes contacting a first surface on a first side of the blank using a first die section including an annular groove formed therein, the annular protrusion extending into the annular groove during the extruding.

5. The method claim 4 wherein the extruding includes contacting a second surface on a second side of the blank opposite the first side using a second die section such that the second die section forms a depression on the second side.

6. The method of claim 5 wherein the second die section includes an axially movable subsection, the axially movable subsection axially moving with respect to a further subsection of the second die section during the extruding.

7. The method of claim 6 wherein the further subsection of the second die section is axially fixed during the extruding.

8. The method claim 4 wherein the first die subsection includes a first internal subsection and a second internal subsection radially outside of the first internal subsection.

9. The method of claim 8 wherein the annular groove is formed radially between the first internal subsection and the second internal subsection.

10. The method of claim 8 wherein the first die section includes an external subsection, the external subsection forcing the first internal subsection and the second internal subsection into the blank during the extruding.

11. The method of claim 1 wherein the blank is a flat plate and the hollow threaded part is formed to include a flat plate radially outside of the annular protrusion.

12. A hollow threaded part comprising:
a base; and
a hollow threaded protrusion segment formed integrally within the base, the hollow threaded protrusion segment including an annular protrusion extruded from the base.

13. The hollow threaded part as recited in claim 12 wherein the base includes first surface, a second surface opposite the first surface and an interior between the first and second surfaces, the annular protrusion extending radially away from the first surface and the interior.

14. The hollow threaded part as recited in claim 13 wherein the hollow threaded protrusion segment includes an annular depression extending radially into the second surface and the interior.

15. The hollow threaded part as recited in claim 12 wherein the annular protrusion includes a cylindrical outer circumferential surface and a threaded inner circumferential surface formed by a projecting helical rib.

16. The hollow threaded part as recited in claim 15 wherein an innermost tip of the rib defines a cylindrically aligned innermost surface of the hollow threaded protrusion segment, the annular protrusion having a consistent thickness between the cylindrically aligned innermost surface and the outer circumferential surface.

17. The hollow threaded part as recited in claim 12 wherein the base is a flat plate.
